(19) United States
(12) Patent Application Publication
(10) Pub. No.: US 2026/0088941 A1
(43) Pub. Date: Mar. 26, 2026

(54) RADIO COMMUNICATIONS

(71) Applicant: Nordic Semiconductor ASA, Trondheim (NO)

(72) Inventor: Eivind Sjøgren OLSEN, Trondheim (NO)

(73) Assignee: Nordic Semiconductor ASA, Trondheim (NO)

(21) Appl. No.: 19/336,058

(22) Filed: Sep. 22, 2025

(30) Foreign Application Priority Data
Sep. 24, 2024 (GB) 2414016.2

(51) Int. Cl. H04L 1/1829; H04L 1/08

(52) U.S. Cl. CPC H04L 1/1858; H04L 1/08

(57) ABSTRACT

A radio transceiver device is provided. The radio transceiver device is arranged to transmit a data packet to a second radio transceiver device, the data packet comprising a header portion and a payload portion comprising a plurality of payload blocks, wherein each payload block comprises a data portion and an error detection portion. The device listens for an acknowledgement packet from the second radio transceiver device comprising an indication of which payload blocks were successfully received. If an acknowledgement packet is received which indicates that one or more payload blocks were not successfully received, the device transmits a further data packet to the second radio transceiver device comprising the one or more payload blocks that were not successfully received. If no acknowledgement packet is received, the device transmits an acknowledgment request packet to the second radio transceiver device.

### CROSS-REFERENCE TO RELATED APPLICATION

This application claims priority from United Kingdom Patent Application No. 2414016.2, filed Sep. 24, 2024, which application is incorporated herein by reference in its entirety.

### BACKGROUND OF THE INVENTION

The present invention relates to radio transceiver devices and methods for operating radio transceiver devices.

Data throughput (i.e. the rate at which a data payload is communicated) is an important consideration in many radio frequency (RF) communication protocols such as Bluetooth Low Energy (Bluetooth LE). In many situations, it is desirable to maximise data throughput, e.g. to enable high quality audio and/or video streaming.

One way of increasing theoretical data throughput in packet-based RF communication protocols is simply to increase the overall duration of each packet, so that a larger payload can be transmitted for each packet overhead (e.g. control data or error detection information). However, simply increasing payload size can be counterproductive, as longer payloads are more likely to encounter interference that can introduce errors in the payload data. Error correcting codes and/or re-transmissions can be used to mitigate the impact of short periods of interference, but both of these measures involve transmitting additional data for a given payload, undermining the goal of increased throughput.

An improved approach may be desired.

### SUMMARY OF THE INVENTION

According to a first aspect of the present invention there is provided a radio transceiver device arranged to:
transmit a data packet to a second radio transceiver device, the data packet comprising a header portion and a payload portion comprising a plurality of payload blocks, wherein each payload block comprises a data portion and an error detection portion;
listen for an acknowledgement packet from the second radio transceiver device comprising an indication of which payload blocks were successfully received;
if an acknowledgement packet is received which indicates that one or more payload blocks were not successfully received, transmit a further data packet to the second radio transceiver device comprising the one or more payload blocks that were not successfully received; and
if no acknowledgement packet is received, transmit an acknowledgment request packet to the second radio transceiver device.

According to a second aspect of the present invention there is provided a method of operating a radio transceiver device comprising:
transmitting a data packet to a second radio transceiver device, the data packet comprising a header portion and a payload portion comprising a plurality of payload blocks, wherein each payload block comprises a data portion and an error detection portion;
listening for an acknowledgement packet from the second radio transceiver device comprising an indication of which payload blocks were successfully received;
if an acknowledgement packet is received which indicates one or more payload blocks that were not successfully received, transmitting a further data packet to the second radio transceiver device comprising the one or more payload blocks that were not successfully received; and
if no acknowledgement packet is received, transmitting an acknowledgment request packet to the second radio transceiver device.

Thus, it will be appreciated by those skilled in the art, that by transmitting an acknowledgment request packet to the second radio transceiver device if an acknowledgement is not received in time, unnecessary data re-transmissions may be avoided. For instance, if an acknowledgment of a partially or entirely successful transmission is corrupted by interference, the radio transceiver device simply requests another acknowledgment rather than re-transmitting the entire data packet including blocks that were already successfully received. The acknowledgment request packet may be considered as the (first) radio transceiver device polling the second radio transceiver device for updated acknowledgment information. The acknowledgment request packet and an acknowledgment packet sent in reply may be referred to as an acknowledgment polling exchange.

Splitting the data payload into blocks with individual error detection portions means that individual blocks affected by interference occurring during the payload portion can be identified and re-transmitted. This, in combination with the acknowledgment request behaviour discussed above, can alleviate the need for complete packet re-transmissions in many interference conditions. This may allow longer payload portions to be used (e.g. up to several ms long) to deliver higher data throughput.

Of course, if all of the payload is successfully received (e.g. because an interferer is not active) the acknowledgement packet will indicate that all of the payload blocks were received. In some embodiments, the first radio transceiver device is arranged, in response to receiving an acknowledgement packet which indicates that all payload blocks were successfully received, to transmit a further data packet to the second radio transceiver device comprising one or more further payload blocks (i.e. blocks that were not transmitted before). The data packet may comprise an indication (e.g. a value in the header portion) that the radio transceiver device has further data to transmit, e.g. to indicate that the second radio transceiver device should continue to listen for further data packets. If there is no more data to transmit, the first radio transceiver device may transmit a null data response packet indicating this to the second radio transceiver device. In other words, a successful transmission followed by a successfully-received acknowledgment may be followed by the radio transceiver device simply proceeding to transmit any further data that is available in a subsequent data packet.

In a set of embodiments, the acknowledgement request packet comprises a header portion (e.g. including preamble bits and control headers). The acknowledgement request packet may further comprise a null data payload portion. However, in some embodiments, the acknowledgement request packet does not include any data payload portion at all (i.e. the acknowledgement request packet consists of a header portion). The acknowledgement request packet may include a single control bit whose value indicates the acknowledgment request. In a set of embodiments the acknowledgement request packet has a duration of 1000 μs or less, 500 μs or less 250 μs or less (e.g. 200 μs or less, 150 μs or less, 100 μs or less or 75 μs or less, such as 69 μs). The acknowledgement request packet may consist of 500 bits or fewer (e.g. 400 bits or fewer, 200 bits or fewer, 200 bits or fewer or 150 bits or fewer such as 138 bits). Keeping the acknowledgement request packet short may reduce energy use and latencies, and provide minor throughput benefits.

The acknowledgement request packet may have the same or similar or format to other packets used by the first and/or second radio transceiver device. For instance, values of one or more bits (e.g. the single control but mentioned above) may determine the packet to be an acknowledgement request packet or another control packet such as a heartbeat packet used to aid synchronisation of the first and second radio transceiver device, or a null data packet indicating that no further data is available from the first radio transceiver device. The acknowledgement request packet may have the same or similar format (e.g. but with one or more different field values) as the acknowledgment packet sent by the second radio transceiver device.

In some embodiments, communication between the radio transceiver devices (i.e. the transmission and acknowledgment of data packets) is done at times that are pre-agreed between the devices. For instance, the radio transceiver devices may be arranged to communicate in pre-agreed communication periods (e.g. periods starting at timing anchors (pre-agreed times). The (first) radio transceiver device may be arranged to transmit the data packet at the start of a communication period (e.g. at a timing anchor). The second radio transceiver device may be arranged to begin listening for a data packet at the start of a communication period. The communication periods may occur at regular intervals (i.e. the timing anchors may be regularly spaced). In a set of embodiments, the communication periods occur with an interval of 2 ms or more, 5 ms or more, 10 ms or more, 50 ms or more, 100 ms or more or 1.0 s or more e.g. between 7.5 ms and 4.0 s. An example of a connection period is a Bluetooth LE connection event or sub event.

A communication period may include only a single data packet and a corresponding acknowledgment (i.e. the first radio transceiver device may be arranged to transmit only a single data packet in a communication period). However, in some embodiments a communication period includes the transmission and acknowledgement of a plurality of data packets. The first radio transceiver device may be arranged to alternate between transmitting a data packet and listening for an acknowledgment in a communication period. In some embodiments, as explained in more detail below, a communication period may include an acknowledgment request packet and an acknowledgment packet in reply to this, before a data packet and its acknowledgment. In other words, a communication period may comprise an acknowledgment polling exchange prior to data transfer.

In a set of embodiments, the (first) radio transceiver device may be arranged to transmit the further data packet (in response to the acknowledgment packet) in a subsequent communication period (e.g. at the start of a subsequent communication period). Similarly, the (first) radio transceiver device may be arranged to transmit the acknowledgment request packet (if no acknowledgment packet for the previous data packet is received) in a subsequent communication period (e.g. at the start of a subsequent communication period).

In other words, a communication period may begin with either a data packet or an acknowledgment request packet, depending on how successful a transmission in a previous communication period was. Co-ordinating data packets and acknowledgment request packets with pre-agreed communication periods can aid reliability. For instance, an acknowledgment packet may include synchronisation or timing information (e.g. length information), so if the acknowledgment packet is not successfully received the absence of this information can make it difficult or impossible to time a subsequent acknowledgment request packet without using a separately agreed timing anchor.

However, it is not essential to co-ordinate the transmission of the acknowledgement request packet pre-agreed communication periods. In some embodiments the (first) radio transceiver device is arranged to transmit the acknowledgment request packet in response to not receiving an acknowledgement packet within a timeout duration after the data packet. Using a fixed timeout duration may allow for missed acknowledges to be re-transmitted more quickly, for instance if the first radio transceiver device wishes to transmit more data in a further data packet before a subsequent communication period begins.

Once the acknowledgment request packet has been transmitted, the radio transceiver device will again listen for the acknowledgment packet from the second radio transceiver device. The radio transceiver device may be arranged to transmit another acknowledgment request packet if an acknowledgment packet is still not received (e.g. by the start of the next communication period or within a further timeout duration). In other words, the radio transceiver device may be arranged to poll repeatedly the second radio transceiver device for an acknowledgment packet if none is successfully received in reply to a data packet.

The acknowledgement packet (transmitted by the second radio transceiver device) may have a first format if all payload blocks were successfully received. For instance, the acknowledgement packet may include a single control bit whose value indicates whether all payload blocks were successfully received. Additionally or alternatively, the acknowledgement packet may include an indication of what data is expected next (e.g. a value of a next expected sequence number (NESN)). The acknowledgement packet may have a second format if one or more payload blocks were not successfully received, e.g. including additional bits used to indicate which blocks were not successfully received.

The further data packet transmitted in response to an acknowledgement packet which indicates that one or more payload blocks were not successfully received (i.e. in response to a partially-successful transmission) may contain only the payload block(s) that were not successfully received. In other words, the first radio transceiver device may be arranged to re-transmit in the next data packet only those blocks which were previously unsuccessful. However, in some embodiments the further data packet may include further data blocks alongside re-transmitted blocks, e.g. to improve throughput. In other words, the further data packet transmitted in response a partially-successful transmission may comprise one or more further payload blocks (i.e. blocks that were not transmitted before).

The header portion of the data packet may include preamble bits (e.g. short training sequence bits and/or long training sequence bits for synchronising the first and second radio transceiver devices). Additionally or alternatively, the header portion of the data packet may include control header bits (e.g. including address information, rate information, block number/length information and/or packet length information).

As explained above, including multiple payload blocks in a single data packet may allow for increased throughout. In a set of embodiments, the data packet comprises two or more payload blocks, four or more payload blocks, eight or more payload blocks or 16 or more payload blocks. Each payload block may comprise at least 100 data bits (e.g. at least 128 data bits). Each payload block may comprise fewer than 300 data bits, fewer than 600 data bits, fewer than 1200 data bits, fewer than 2400 data bits or fewer than 3000 data bits. Each payload block may have a duration of 100 μs or less (e.g. approximately 64 μs), 150 μs or less (e.g. approximately 128 μs), 200 μs or less (e.g. approximately 192 μs) or 500 μs or less (e.g. approximately 256 μs). In a set of embodiments, the data packet comprises an overall duration of 1 ms or more, 2 ms or more or 3 ms or more. In a set of embodiments, the payload portion is ten or more times longer than the header portion (e.g. 15 or more times, 20 or more times, 25 or more times, 30 or more times, 35 or more times or 40 or more times). A high ratio of payload to header overhead is useful for obtaining high data throughput. In some embodiments, the data packet may comprise a plurality of independent payload portions (e.g. up to four), each of which comprises a plurality of payload blocks. In such embodiments, the further data packet (that is transmitted to the second radio transceiver device if an acknowledgement packet is received which indicates one or more payload blocks that were not successfully received) may comprise payload blocks from different payload portions. In other words, re-transmitted blocks may be from different payload portions.

The second radio transceiver may use the error detection portions to determine which payload blocks have been successfully received (e.g. to identify which blocks need to be re-transmitted). For instance, the error detection portions may include one or more check values that can be used by the second radio transceiver device to determine if the associated data portion of the payload block includes any errors, such as errors caused by interference during the transmission of the payload block (e.g. single flipped bits or larger parts that were obscured by interference). One or more of the error detection portions may comprise a cyclic redundancy check value (i.e. one or more CRC check bits). The second radio transceiver device can verify a CRC check value for a payload block to quickly determine if the associated data portion has been successfully received.

In some embodiments, the error detection portion may comprise an error correcting portion, e.g. include one or more values that can be used to correct one or more errors in the data portion. However, this is not essential as simply detecting transmission errors and requesting re-transmissions as needed can suffice in many situations.

Embodiments of the invention may be particularly useful in environments where other radio protocols (e.g. WiFi) use “listen before talk” sensing to avoid conflicts. Such radios may begin transmitting in the space after the end of the data packet, potentially interfering with the subsequent acknowledgment packet.

In a set of embodiments, the radio transceiver device is arranged to communicate (i.e. send and receive data) using radio waves in one or more license-exempt frequency bands (e.g. an industrial, scientific, and medical (ISM) band such as 2.4 GHz). For instance, the radio transceiver device may be arranged to communicate according to a Bluetooth protocol (e.g. Bluetooth LE). The applicant has recognised that the approach disclosed herein may be particularly useful for radios that utilise unlicensed frequencies as there are often multiple such radios provided in the same physical device (e.g. a portable electronic device such as a laptop or smart phone which includes Bluetooth and IEEE 802.11 (WiFi) radios).

The invention extends to a device comprising:
a radio transceiver device as disclosed herein, arranged to communicate using a first range of frequencies, and
a co-existing radio transceiver device arranged to communicate using a second range of frequencies;
   wherein the first and second range of frequencies at least partially overlap.

The radio transceiver device and the co-existing radio transceiver device may communicate according to the same communication protocol (e.g. Bluetooth), or according to different communication protocols (e.g. Bluetooth and WiFi). The co-existing radio transceiver device may also be arranged as disclosed herein.

The invention also extends to software that, when executed by a radio transceiver device, causes said radio transceiver device to perform the method according to the second aspect disclosed herein. The radio transceiver device may comprise a memory storing part or all of said software. The radio transceiver device may comprise a processor arranged to execute part or all of said software.

According to a third aspect of the present invention there is provided a radio transceiver device arranged to:
receive a data packet from a first radio transceiver device, the data packet comprising a header portion and a payload portion comprising a plurality of payload blocks, wherein each payload block comprises a data portion and an error detection portion;
determine which of the payload blocks have been successfully received;
transmit an acknowledgement packet to the first radio transceiver device comprising an indication of which payload blocks were successfully received;
listen for an acknowledgment request packet from the first radio transceiver device; and
in response to receiving the acknowledgment request packet from the first radio transceiver device, re-transmit the acknowledgement packet to the first radio transceiver device.

According to a fourth aspect of the present invention there is provided a method of operating a radio transceiver device comprising:
receiving a data packet from a first radio transceiver device, the data packet comprising a header portion and a payload portion comprising a plurality of payload blocks, wherein each payload block comprises a data portion and an error detection portion;
determining which of the payload blocks have been successfully received;
transmitting an acknowledgement packet to the first radio transceiver device comprising an indication of which payload blocks were successfully received;
listening for an acknowledgment request packet from the first radio transceiver device; and
in response to receiving the acknowledgment request packet from the first radio transceiver device, re-transmitting the acknowledgement packet to the first radio transceiver device.

It will be appreciated that all of the preferred features of the second radio transceiver device and radio transceiver device described above with reference to the first and second aspects above may be applied to the radio transceiver device and first radio transceiver device respectively of the third and fourth aspects.

The invention also extends to software that, when executed by a radio transceiver device, causes said radio transceiver device to perform the method according to the fourth aspect disclosed herein. The radio transceiver device may comprise a memory storing part or all of said software. The radio transceiver device may comprise a processor arranged to execute part or all of said software. The invention extends to a non-transitory computer readable medium on which said software is stored.

The present invention extends to a radio communication system comprising a first radio transceiver device according to the first aspect of the invention arranged to communicate with a second radio transceiver device according to the third aspect of the invention.

The invention also extends to a method of operating a radio communication system comprising operating a first radio transceiver device using a method according to the second aspect of the invention and operating a second radio transceiver device using a method according to the fourth aspect of the invention, to communicate data from the first radio transceiver device to the second radio transceiver device.

Features of any aspect or embodiment described herein may, wherever appropriate, be applied to any other aspect or embodiment described herein.

Where reference is made to different embodiments, it should be understood that these are not necessarily distinct but may overlap. It will be appreciated that all of the preferred features of the radio transceiver devices, methods of operation and system described with reference to the first and second aspects described above may also apply as appropriate to the other aspects of the invention.

### BRIEF DESCRIPTION OF THE DRAWINGS

One or more non-limiting examples will now be described, by way of example only, and with reference to the accompanying figures in which:

FIG. 1 is a schematic diagram of a radio communication system according to an example of the present invention;

FIG. 2 is a schematic diagram of a data packet used by the radio communication system;

FIG. 3 is a schematic diagram of an acknowledgment request packet used by the radio communication system;

FIG. 4 is a flow diagram illustrating operation of the radio communication system; and

FIGS. 5 and 6 are timing diagrams illustrating operation of the radio communication system.

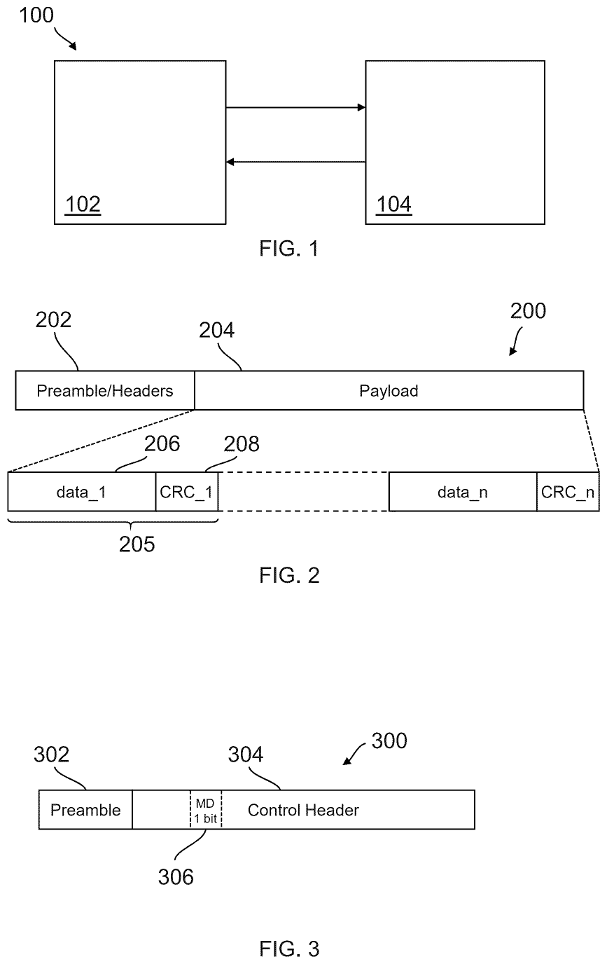

FIG. 1 shows a radio communication system 100 comprising a first radio transceiver device 102 and a second radio transceiver device 104. In this example, the first and second radio transceiver devices 102, 104 are Bluetooth LE devices.

The first and second radio transceiver devices 102, 104 communicate by transmitting packets containing payload data. For simplicity, the system 100 will be described below in the context of data being transmitted from the first radio transceiver device 102 to the second radio transceiver device. However, it will be appreciated that in at least some examples the radio transceiver devices 102, 104 may be able to communicate payload data in both directions (i.e. with data packets being sent from the first radio transceiver device 102 to the second radio transceiver device 104 and from the second radio transceiver device 104 to the first radio transceiver device 102).

An example data packet 200 is shown in FIG. 2. The data packet 200 comprises a header portion 202, which includes preamble and control bits, and a payload portion 204 which includes the data payload. The payload portion 204 is split into a plurality of blocks 205 (from block 1 to block n), with each block 205 including a data portion 206 (data_1, . . . , data_n) and an error detection portion 208 (CRC_1, . . . , CRC_n). The error detection portions 208 comprise cyclic redundancy check (CRC) bits for their respective data portions 206. The data portion 206 of each block 205 may include up to 240 data octets. The payload portion 204 may include up to 16 blocks.

The Bluetooth LE communication between the two radio transceiver devices 102, 104 protocol utilises the license-exempt 2.4 GHz frequency band which can often be congested. For instance, one or both of the radio transceiver devices 102, 104 may be provided in a device (e.g. a smartphone) which also features a WiFi radio device using the same 2.4 GHz frequency band. The radio transceiver devices 102, 104 can use frequency hopping and other techniques known in the art per se to mitigate interference, but there remains a risk of interference preventing some or all of a data packet being received.

To mitigate the loss of data to interference, the second radio transceiver device 104 sends acknowledgment packets in reply to data packets received from the first radio transceiver device 102, to indicate that the packet was successfully received or if data needs to be re-transmitted.

Because the payload portion 204 is split into blocks 205 with individual error detection portions 208, if interference affects only part of the payload (e.g. a limited number of blocks 205), only the affected blocks may need to be re-transmitted. The second receiving device 104 uses the error detection portions 208 to identify unsuccessful blocks 205, and then sends an acknowledgment packet which indicates the blocks 205 that need to re-transmitted in the next data packet. Thus, a full re-transmission of the data packet 200 may be avoided in many interference situations, improving throughput.

However, in some situations (e.g. late interference) this acknowledgement packet may itself not be successfully received. This leaves the first radio transceiver device 102 with no information on how successful the transmission of a data packet was. To avoid potentially-unnecessary full re-transmissions of data in this situation, the first radio transceiver device 102 sends an acknowledgment request packet to the second radio transceiver device 104 if no acknowledgment is received. This prompts the second radio transceiver device 104 to re-transmit the acknowledgment packet.

An example acknowledgment request packet 300 is shown in FIG. 3. The acknowledgment request packet 300 consists of a preamble portion 302 and a control header portion 304. The acknowledgment request packet 300 does not include any payload data fields, to minimise its duration. The control header portion 304 includes a more data (MD) field 306. When the more data field 306 has a value of “1” but there is no data payload, this is interpreted by the second radio transceiver device 104 as an acknowledgment request packet 300. The same format of packet may be used for other purposes by assigning a different value to the more data field 306 and/or by adding payload fields after the control header portion 204.

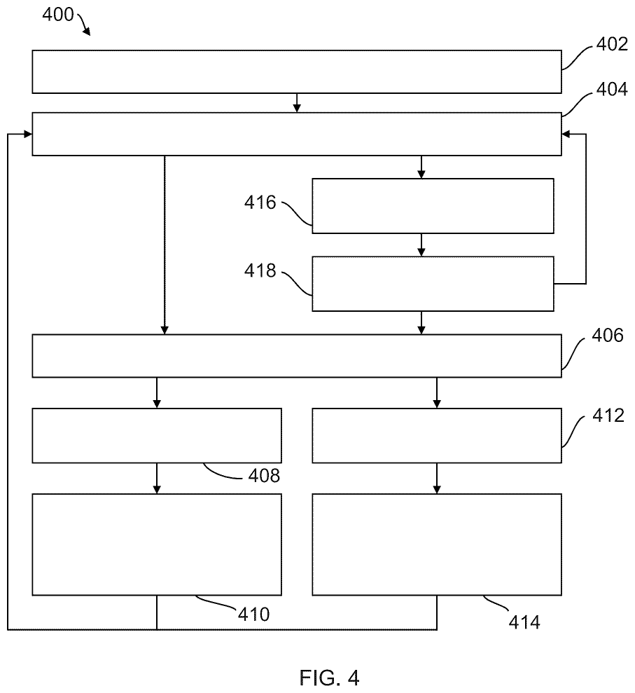

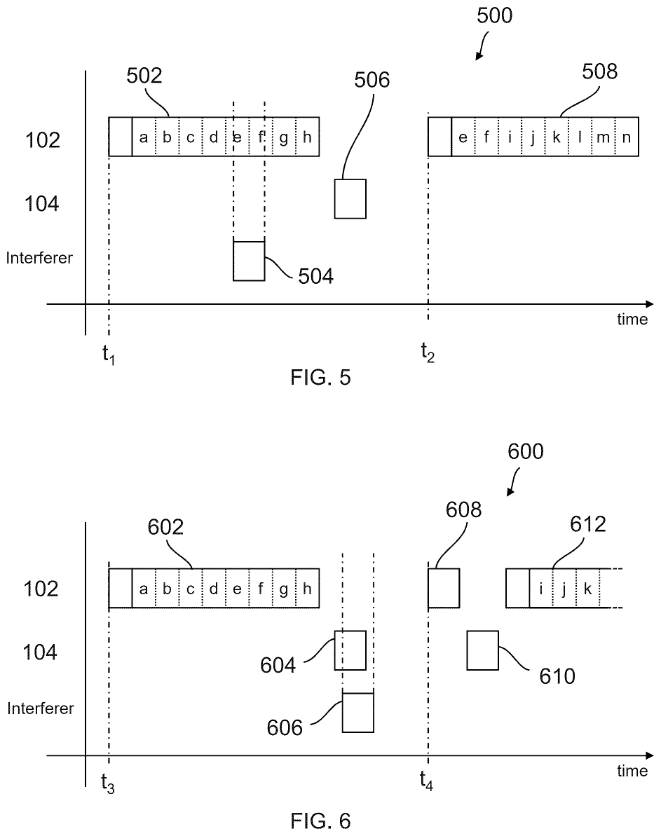

The operation of the radio communication system 100 will now be described with reference to FIGS. 4, 5 and 6. It is noted that the timing diagrams in FIG. 5 are not drawn to scale. In reality, the data packets 200 may be significantly longer than acknowledgment packets and/or any intervals between packets.

FIG. 4 shows a communication process 400 for transmitting data from the first radio transceiver device 102 to the second radio transceiver device 104. This process will now be described with reference to an interference situation shown in timing diagram 500 in FIG. 5.

The communication between the first and second radio transceiver devices 102, 104 occurs in regular connection events, whose timing is pre-agreed between the devices 102, 104. FIG. 5 shows two connection events. The first connection event starts at a first pre-agreed timing anchor t₁ and the second connection event starts a second pre-agreed timing anchor t₂.

In a first step 402, at the start t₁ of the first connection event, the first radio transceiver device 102 transmits a data packet 502. The data packet 402 includes eight payload blocks labelled a to h. An interferer 504 is active during the transmission of blocks e and f, preventing their data from being successfully received by the second radio transceiver device 104.

The transmission of the data packet 502 ends, and in step 404 the first radio transceiver device 102 listens for an acknowledgement packet sent by the second radio transceiver device 104 to indicate if and how successfully the data packet 502 was received. The second radio transceiver device 104 checks the CRC bits for each block and determines that blocks e and f were not successfully received (due to the presence of the interferer), and transmits an acknowledgment packet 506 indicating this. The interferer is no longer active and so the acknowledgement packet is received successfully by the first radio transceiver device 102 in step 406. This ends the first connection event.

The first radio transceiver device 102 processes the acknowledgment packet 506 and notes in step 412 that it indicates that several of the payload blocks were not successfully received. Accordingly, when the second connection event begins at t₂, in step 414 the first radio transceiver device 102 re-transmits these missing blocks as part of the next data packet 508. The first radio transceiver device 102 then returns to step 404 to listen for an acknowledgment of this next data packet 508. It will be appreciated that, because the payload of data packet 502 was split into blocks with individual error detection portions, only the blocks that were in conflict with the interferer need to be re-transmitted, rather than the entire packet 502. This increases data throughput.

This process will now be described with reference to a different interference situation shown in timing diagram 600 in FIG. 6. This also shows two connection events. The first connection event starts at a first pre-agreed timing anchor t₃ and the second connection event starts a second pre-agreed timing anchor t₄.

In a first step 402, at the start t₃ of the first connection event, the first radio transceiver device 102 transmits a data packet 602. The data packet 602 again includes eight payload blocks labelled a to h. In this situation, there is no interferer active during the transmission of the data packet 602.

The transmission of the data packet 602 ends, and in step 404 the first radio transceiver device 102 listens for an acknowledgement packet sent by the second radio transceiver device 104 to indicate if and how successfully the data packet 602 was received. The second radio transceiver device 104 checks the CRC bits for each block and determines that all blocks were received correctly. An acknowledgment packet 604 indicating this is transmitted. However, an interferer 606 is now active (e.g. a radio device which does listen-before-talk sensing), which prevents the acknowledgment packet from being received successfully by the first radio transceiver device 102.

In step 416, no acknowledgement has been received by the first radio transceiver device 102. Therefore, at the start of the second connection event at t₄, in step 418 the first radio transceiver device 102 transmits an acknowledgment request packet 608 to the second radio transceiver device 104 and then returns to step 404 to listen for an acknowledgement packet.

The acknowledgment request packet 608 is a request for the second radio transceiver device 104 to re-transmit its acknowledgment. The interference has now ended, so the acknowledgment request packet 608 is successfully received by the second radio transceiver device 104, which obliges and transmits a new acknowledgment packet 610. This is received successfully by the first radio transceiver device 102 in step 406.

The first radio transceiver device 102 then processes the acknowledgment packet 610 and notes in step 408 that it indicates that all of the payload blocks were successfully received. Accordingly, in step 410 the first radio transceiver device 102 simply proceeds to transmit the next data packet 612 (i.e. containing the next payload blocks and no re-transmissions). The first radio transceiver device 102 then returns to step 404 to listen for an acknowledgment of this next data packet 612. In FIG. 6 the transmission of the next data packet 612 occurs as part of the second connection event, but in other examples the next data packet 612 may be sent at the start of a subsequent connection event (not shown)

It will be appreciated that, because the first radio transceiver device 102 sent the acknowledgment request packet 608 rather than simply re-transmitting the entire data packet 602, the system proceeds to the next data packet 612 much earlier, increasing data throughput.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A radio transceiver device arranged to:
transmit a data packet to a second radio transceiver device, the data packet comprising a header portion and a payload portion comprising a plurality of payload blocks, wherein each payload block comprises a data portion and an error detection portion;
listen for an acknowledgement packet from the second radio transceiver device comprising an indication of which payload blocks were successfully received;
if an acknowledgement packet is received which indicates that one or more payload blocks were not successfully received, transmit a further data packet to the second radio transceiver device comprising the one or more payload blocks that were not successfully received; and
if no acknowledgement packet is received, transmit an acknowledgment request packet to the second radio transceiver device.

2. The radio transceiver device of claim 1, wherein the acknowledgement request packet consists of a header portion.

3. The radio transceiver device of claim 1, wherein the acknowledgement request packet includes a single control bit whose value indicates the acknowledgment request.

4. The radio transceiver device of claim 1, wherein the acknowledgement request packet has a duration of 1000 μs or less.

5. The radio transceiver device of claim 1, wherein the acknowledgement request packet has the same format as the acknowledgment packet sent by the second radio transceiver device.

6. The radio transceiver device of claim 1, arranged to transmit the data packet at the start of a pre-agreed communication period, and to transmit the acknowledgment request packet in a subsequent pre-agreed communication period.

7. The radio transceiver device of claim 1, wherein the data packet comprises four or more payload blocks.

8. The radio transceiver device of claim 1, arranged to communicate according to a Bluetooth protocol.

9. The radio transceiver device of claim 1, wherein the acknowledgement request packet differs from the acknowledgment packet sent by the second radio transceiver device by only a single control bit value.

10. The radio transceiver device of claim 1, wherein the acknowledgment request packet has a duration of 75 μs or less.

11. A device comprising:
the radio transceiver device of claim 1, arranged to communicate using a first range of frequencies, and
a co-existing radio transceiver device arranged to communicate using a second range of frequencies;
wherein the first and second range of frequencies at least partially overlap.

12. A method of radio communication comprising:
a first radio transceiver device transmitting a data packet to a second radio transceiver device, the data packet comprising a header portion and a payload portion comprising a plurality of payload blocks, wherein each payload block comprises a data portion and an error detection portion;
the first radio transceiver device listening for an acknowledgement packet from the second radio transceiver device comprising an indication of which payload blocks were successfully received;
if an acknowledgement packet is received which indicates one or more payload blocks that were not successfully received, the first radio transceiver device transmitting a further data packet to the second radio transceiver device comprising the one or more payload blocks that were not successfully received; and
if no acknowledgement packet is received, the first radio transceiver device transmitting an acknowledgment request packet to the second radio transceiver device.

13. The method of claim 12, further comprising:
the second radio transceiver device receiving the data packet from the first radio transceiver device;
the second radio transceiver device determining which of the payload blocks have been successfully received;
the second radio transceiver device transmitting an acknowledgement packet to the first radio transceiver device comprising an indication of which payload blocks were successfully received;
the second radio transceiver device listening for an acknowledgment request packet from the first radio transceiver device; and
in response to receiving the acknowledgment request packet from the first radio transceiver device, the second radio transceiver device re-transmitting the acknowledgement packet to the first radio transceiver device.
